(19) United States
(12) Patent Application Publication
(10) Pub. No.: US 2025/0077959 A1
(43) Pub. Date: Mar. 6, 2025

(54) SMOOTH BLENDING OF MACHINE LEARNING MODEL VERSIONS

(71) Applicant: AMPERITY, INC., Seattle, WA (US)

(72) Inventors: Yan YAN, Seattle, WA (US); Pranav Behari LAL, Seattle, WA (US); Nicholas RESNICK, Brooklyn, NY (US); Joyce GORDON, Seattle, WA (US)

(21) Appl. No.: 18/461,703

(22) Filed: Sep. 6, 2023

(51) Int. Cl. G06N 20/00

(52) U.S. Cl. CPC G06N 20/00

(57) ABSTRACT

In some implementations, the techniques described herein relate to a method including: loading a current and a new model, the new model including the most recent version of the current model; computing a migration duration based on computed properties, namely the jitter in predictions between the current and the new models based on imputing the same inference data to both models; blending outputs of the current model with outputs of the new model according to weights computed for a current time step in the migration process; and serving new predictions using the new model when the migration duration expires.

### BACKGROUND

In machine learning (ML) systems, model creators frequently improve upon and update models. Such updates generally involve the replacing of older models with newer models. Frequently, these changes do not impact the inputs to the model but often have drastic effects on the outputs which can be too significant or large for downstream applications that rely on the output of the models to handle appropriately.

### BRIEF DESCRIPTION OF THE FIGURES

FIG. 1 is a block diagram illustrating a system for blending model predictions during a migration according to some of the example embodiments.

FIG. 2 is a flow diagram illustrating a method for blending model predictions over a migration duration according to some of the example embodiments.

FIG. 3 is a flow diagram illustrating a method for blending model predictions using a fixed step approach according to some of the example embodiments.

FIG. 4 is a flow diagram illustrating a method for blending model predictions using a computed step approach according to some of the example embodiments.

FIG. 5 is a flow diagram illustrating a method for blending model predictions using a dynamically computed step approach according to some of the example embodiments.

FIG. 6 is a block diagram of a computing device according to some embodiments of the disclosure.

### DETAILED DESCRIPTION

The example embodiments relate to techniques for updating machine learning (ML) models, specifically addressing the problem of prediction “jitter” that results from significant changes in model configurations. As used herein, jitter refers to the difference in predictive outputs between two versions of a model, the two versions designed to predict the same target variable. The current state of ML model development and deployment often results in negative impacts when updates are applied, due to substantial disruptions in the output predictions. Traditional approaches to model migration, such as an immediate switch to a new model (e.g., a planned one-time migration), often lead to a sharp introduction of jitters which are uncontrolled and could adversely affect downstream applications, ranging from e-commerce systems to content generation platforms. Furthermore, currently there is a lack of efficient tools to support incremental model migration. This deficit prevents the application of significant model updates and, thus, forces the maintenance of outdated and inefficient legacy models that offer increasingly poor predictive performance.

The disclosed embodiments provide a solution to this issue by enabling a controlled and smooth transition from an old to a new ML model, thereby reducing the impact of jitters. Unlike a quick-switch migration, the smooth-transition or smooth-blend approach proposed in this disclosure allows the gradual incorporation of changes over a period, thereby minimizing the disruption in predictive outputs. This is achieved by blending predictions from the old and new models, with the daily level of jitter managed by specifying a daily threshold (and the distance between new and old predictions relative to the daily threshold) or a migration duration. Alternatively, and in some implementations, only the migration duration may be specified and each time step's jitter is a function of the migration duration. Therefore, the model migration duration is inversely proportional to the magnitude of the jitter, leading to a longer transition period for larger jitters.

Further, the disclosed embodiments prioritize simplicity in modifications of the migration tenant's training and inference workflow, aiming to avoid unnecessary complexity. This tooling facilitates several significant improvements in ML model management and development: it ensures that model advancements benefit all customers, regardless of their tenure; it enables cost reductions by facilitating algorithm clean-ups; it obviates the need for maintaining outdated legacy models; and it empowers data scientists by liberating them from dealing with inefficient and outdated systems.

In conclusion, the disclosed embodiments address the significant technical problem of managing ML model migrations in a way that controls jitter, optimizes performance, reduces costs, and enhances the overall ML model development and deployment process. By doing so, it enables a significantly improved, more efficient, and less disruptive way to update ML models, thereby providing significant advantages to data scientists and end users alike.

In some implementations, the techniques described herein relate to a method including: loading a first model and a second model, the second model including a later version of the first model; computing a migration duration based on a computed property of the first model and the second model; inputting inference data into both the first model and the second model; blending outputs of the first model with outputs of the second model according to weights computed for a first time step of the migration duration; and serving second inference data using the second model when migration duration expires.

In some implementations, the techniques described herein relate to a method, wherein computing the migration duration based on the computed property of the first model and the second model includes: computing an estimated number quantifying the scale of changes of the second model when compared to the first model; and computing the migration duration based on the estimated number quantifying the scale of changes.

In some implementations, the techniques described herein relate to a method, wherein blending the outputs of the first model with outputs of the second model includes linearly computing a first weight of the first model and a second weight of the second weight of the second model based on the first time step, wherein a sum of the first weight and the second weight is equal to one.

In some implementations, the techniques described herein relate to a method, wherein computing the migration duration based on the computed property of the first model and the second model includes: computing a jitter size of the second model when compared to the first model; and computing the migration duration based on the jitter size and a predefined jitter size.

In some implementations, the techniques described herein relate to a method, wherein computing the migration duration based on the jitter size includes: dividing the jitter size by a jitter threshold to obtain the migration duration.

In some implementations, the techniques described herein relate to a method, further including: computing second weights for a second time step according to a model blend weight, the model blend weight based on a jitter size of a blended output of the first time step and a model blend weight computed for the first time step; and blending outputs of the first model with outputs of the second model according to the second weights.

In some implementations, the techniques described herein relate to a method, further including determining that the migration duration expires when a summation of previous model blend weight is equal to one.

In some implementations, the techniques described herein relate to a non-transitory computer-readable storage medium for tangibly storing computer program instructions capable of being executed by a computer processor, the computer program instructions defining steps of: loading a first model and a second model, the second model including a later version of the first model; computing a migration duration based on a computed property of the first model and the second model; inputting input inference data into both the first model and the second model; blending outputs of the first model with outputs of the second model according to weights computed for a first time step of the migration duration; and serving second inference data using the second model when migration duration expires.

In some implementations, the techniques described herein relate to a non-transitory computer-readable storage medium, wherein computing the migration duration based on the computed property of the first model and the second model includes: computing an estimated number quantifying the scale of changes of the second model when compared to the first model; and computing the migration duration based on the estimated number quantifying the scale of changes.

In some implementations, the techniques described herein relate to a non-transitory computer-readable storage medium, wherein blending the outputs of the first model with outputs of the second model includes linearly computing a first weight of the first model and a second weight of the second model based on the first time step, wherein a sum of the first weight and the second weight is equal to one.

In some implementations, the techniques described herein relate to a non-transitory computer-readable storage medium, wherein computing the migration duration based on the computed property of the first model and the second model includes: computing a jitter size of the second model when compared to the first model; and computing the migration duration based on the jitter size and a predefined jitter size.

In some implementations, the techniques described herein relate to a non-transitory computer-readable storage medium, wherein computing the migration duration based on the jitter size includes dividing the jitter size by a jitter threshold to obtain the migration duration.

In some implementations, the techniques described herein relate to a non-transitory computer-readable storage medium, the steps further including: computing second weights for a second time step according to a model blend weight, the model blend weight based on a jitter size of a blended output of the first time step and a model blend weight computed for the first time step; and blending outputs of the first model with outputs of the second model according to the second weights.

In some implementations, the techniques described herein relate to a non-transitory computer-readable storage medium, the steps further including determining that the migration duration expires when a summation of previous model blend weight is equal to one.

In some implementations, the techniques described herein relate to a device including: a processor; and a storage medium for tangibly storing thereon logic for execution by the processor, the logic including instructions for: loading a first model and a second model, the second model including a later version of the first model, computing a migration duration based on a computed property of the first model and the second model, inputting inference data into both the first model and the second model, blending outputs of the first model with outputs of the second model according to weights computed for a first time step of the migration duration, and serving second inference data using the second model when migration duration expires.

In some implementations, the techniques described herein relate to a device, wherein computing the migration duration based on the computed property of the first model and the second model includes: computing an estimated number quantifying the scale of changes of the second model when compared to the first model; and computing the migration duration based on the estimated number quantifying the scale of changes.

In some implementations, the techniques described herein relate to a device, wherein blending the outputs of the first model with outputs of the second model includes linearly computing a first weight of the first model and a second weight of the second weight of the second model based on the first time step, wherein a sum of the first weight and the second weight is equal to one.

In some implementations, the techniques described herein relate to a device, wherein computing the migration duration based on the computed property of the first model and the second model includes: computing a jitter size of the second model when compared to the first model; and computing the migration duration based on the jitter size and a predefined jitter size.

In some implementations, the techniques described herein relate to a device, wherein computing the migration duration based on the jitter size includes dividing the jitter size by a jitter threshold to obtain the migration duration.

In some implementations, the techniques described herein relate to a device, the instructions further including: computing second weights for a second time step according to a model blend weight, the model blend weight based on a jitter size of a blended output of the first time step and a model blend weight computed for the first time step; and blending outputs of the first model with outputs of the second model according to the second weights.

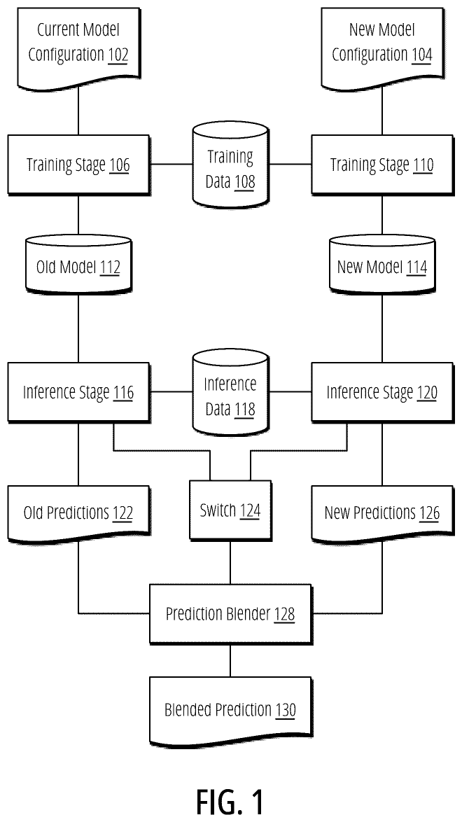

FIG. 1 is a block diagram illustrating a system for blending model predictions during a migration according to some of the example embodiments.

The system includes a current model configuration 102 that is used by a training stage 106 to train an old model 112 (also referred to as a “current” model) using training data 108. The system further includes a new model configuration 104 used by training stage 110 to train a new model 114 using training data 108. In some implementations, although illustrated separately, training stage 106 and training stage 110 may be implemented as a single training stage configurable using, for example, current model configuration 102 or new model configuration 104. Further, in some implementations, both training stages may use the same training dataset stored in training data 108.

In some implementations, current model configuration 102 and new model configuration 104 may comprise configuration files (e.g., flat files) such as a serialized file (e.g., YAML, JSON, XML, etc.). In some implementations, these files can store the properties for training a model such as, but not limited to, a batch size, optimizer function, learning rate, test size, and evaluation metric. As one example, current model configuration 102 and new model configuration 104 may be configuration files suitable for configuring a model lifecycle in MLFLOW® or a similar ML model configuration platform. In some implementations, current model configuration 102 and new model configuration 104 may store properties that are comparable in that changes between configurations can be computed to determine the number of changes required to use a new model configuration 104 compared to current model configuration 102.

In some implementations, training stage 106 may comprise a model training routine. For example, it may involve multiple steps such as preprocessing the training data 108, training the old model 112 using the preprocessed data and the current model configuration 102, and evaluating the performance of the model using a validation dataset. The model training routine could also involve optimization of the model parameters based on the evaluation metric stored in the current model configuration 102. Similarly, training stage 110 may involve a corresponding training routine for the new model 114, using the new model configuration 104. Both training stages may optionally include steps for hyperparameter tuning, where different sets of hyperparameters are used to train multiple versions of the models, and the version that performs best according to a selected evaluation metric is chosen as the final model. The entire training process may be automated and repeated periodically to ensure the models stay up to date with the latest available training data 108. No limitation is placed on the type and shape of the data stored in training data 108, as any suitable training data may be used. For example, the training data 108 may take the form of a series of labels and feature vectors containing features. Further, no limit is placed on the type of model used for old model 112 and new model 114. Indeed, any model that may be trained or otherwise created using training data or other approaches (e.g., unsupervised) can be used.

As illustrated, each model (e.g., old model 112 and new model 114) may be deployed and used in product via inference stage 116 and inference stage 120, respectively. In some implementations, an inference stage refers to the process of using a trained model to make predictions on new, unseen data stored in, for example, inference data 118. This typically involves preprocessing the inference data 118 in the same way as the training data, then feeding it through a given model to generate predictions, and finally transmitting the predictions as needed before they are used or presented. The inference stages may also include a system for monitoring the performance of the deployed models in real time, using techniques such as anomaly detection or drift detection to identify any significant changes in the models' performance or the data they are processing. If such changes are detected, it may trigger retraining of the models with updated configurations and/or data, ensuring the models continue to perform optimally even as the environment changes.

In some implementations, the system may run both old model 112 and new model 114 via inference stage 116 and inference stage 120 in parallel. That is, each item of inference data 118 may be run through both models. As such, inference stage 116 may generate old predictions 122 (also referred to as current predictions) while inference stage 120 may simultaneously generate new predictions 126. As will be discussed, a prediction blender 128 can receive both predictions, and based on the methods described herein, can operate a switch 124 to toggle and/or blend predictions from both models (i.e., inference stage 116 and inference stage 120).

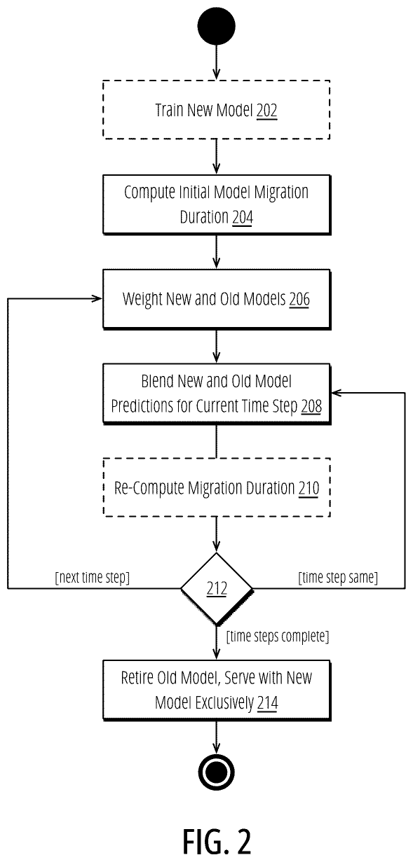

As a result, the prediction blender 128 can output blended predictions 130. In some implementations, the blended predictions 130 can comprise a weighted version of a summation or other aggregation of old predictions 122 and new predictions 126. In some implementations, the prediction blender 128 can further operate switch 124 to incrementally adjust the weighting of old predictions 122 and new predictions 126 (described more fully in FIGS. 2 through 5). In some implementations, the prediction blender 128 can ultimately stop using old predictions 122 and only serve new predictions 126 from inference stage 120 In this scenario, prediction blender 128 may further be configured to “retire” old model 112 and use only new model 114 moving forward, or until a next model is trained using the foregoing process.

In the foregoing system, current model 112 is initially used to handle all inference data for end users. At some point, new model 114 is trained and completed. In existing systems, new model 114 would generally be “hot swapped” or otherwise used to replace old model 112. However, doing so can result in significant “jitter” in predictions. For example, if the models are binary prediction models, the new model may predict true results where the old model predicted false results. As such, the deployment of new model 114 can cause significant disruptions to downstream applications that rely on the output of the model. For example, downstream applications may comprise e-commerce systems, content generation systems, mail systems, or other systems that need predictive data to perform operations. To address this technical challenge in deploying new ML models, the prediction blender 128 dynamically adjusts the weighting of the two models which are run simultaneously and then blends the outputs until the new model 114 can be used exclusively. As a result, the system can seamlessly transition between models with minimal to no impact on downstream processes. Further operational and functional details of the system are provided in the following flow diagrams, the details of which are incorporated by reference in their entirety.

FIG. 2 is a flow diagram illustrating a method for blending model predictions over a migration duration according to some of the example embodiments.

In step 202, the method may optionally include training a new model. As discussed in FIG. 1, a new model refers to an ML model that is trained or otherwise deployed using parameters or other aspects that differ from an old or current model. The specific details of obtaining this new model are not limiting and thus optional.

In step 204, the method can include computing an initial model migration duration.

In some implementations, at an initial time, the method may be serving predictions using the current model and may then migrate to the new model. In existing systems, this migration happens instantaneously by wholly replacing the old model with the new one. While this provides instant migration, it introduces significant jitter. As will be discussed, the method herein provides a process for transitioning from the old model to the new model over a period of time referred to as the migration duration.

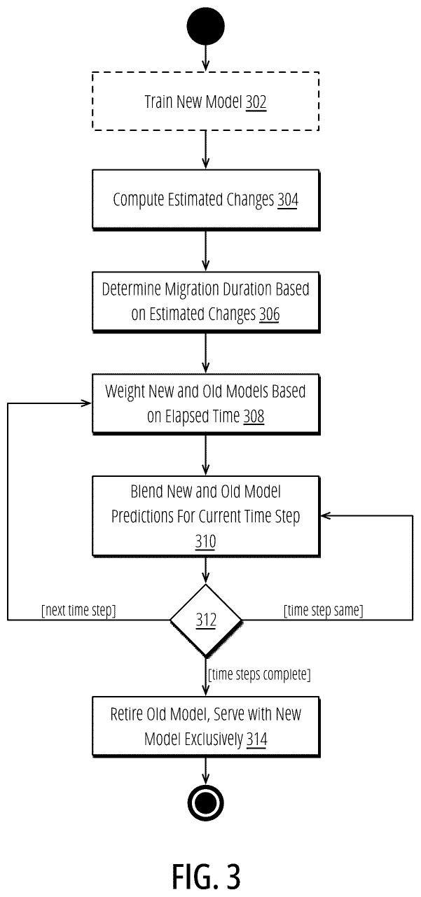

In some implementations, various techniques can be used to determine the migration duration. More details on these techniques are provided in FIGS. 3 through 5 and not repeated in detail herein. In general, however, the method may use a fixed duration (e.g., a static time period in which to migrate a model, such as three weeks), a computed duration based on changes (e.g., a dynamically calculated period based on the extent of changes between the old and new model), or a computed duration based on the initial jitter (e.g., a duration dependent on how significant the jitter introduced by the new model is). Specific details on how to compute these durations are described later.

In step 206, the method can include weighting the new model and the old model. Then, in step 208, the method can blend the new and old model predictions for a current time step based on the weights.

In some implementations, the outputs (i.e., predictions) of the model are of the same type and thus are capable of being aggregated (e.g., summed). For example, both models may predict the likelihood of a customer churning (a floating-point value) or the lifetime value of a customer (an integer or floating-point value).

Before outputting a prediction, the method first determines how much weight should be placed on both models. As illustrated in the return loop from step 212, this process can be repetitive such that the weights are updated as the migration is pending. In some implementations, the weights total a value of one. As an example, the method may (at an initial time step) weight the old model at 90% (0.9) and the new model at 10% (0.1). Thus, if the new model predicts a value of 0.8 and the new model predicts a value 0.2, the method (in step 208) can blend these two models as 0.800(0.900)+0.100(0.200)=0.738. As can be seen, in an existing migration framework, this prediction (from 80% to 20%) would cause significant jitter, effectively flipping the prediction of the old model. However, by blending two separately trained models, the method can minimize the impact of this jitter for downstream applications.

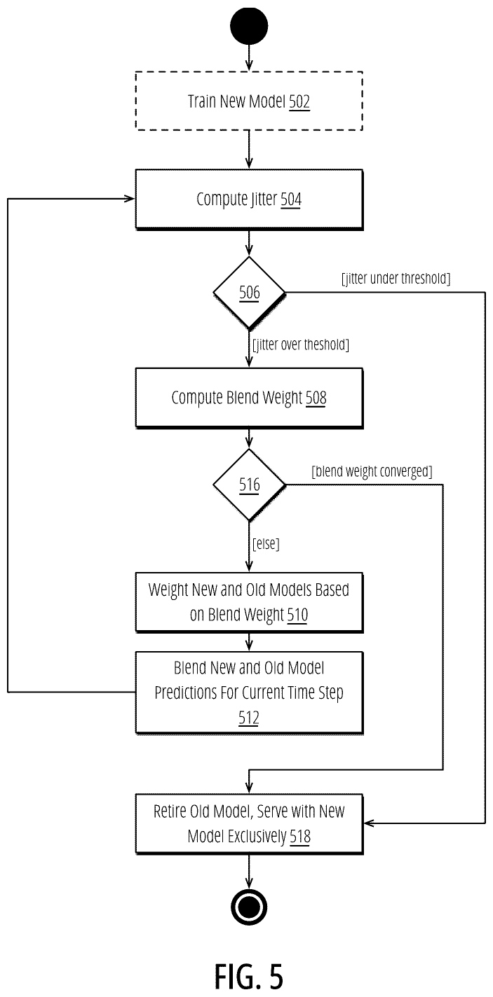

In optional step 210, the method may recompute the migration duration. More details on this optional step are provided in FIG. 5 which is not repeated herein. If implemented, the method can analyze the jitter of the blended predictions and dynamically update the migration duration if the jitter stabilizes or increases, accordingly.

In step 212, the method can include determining the state of the migration. If the migration is still in the current time step, the method continues to serve predictions in step 208. If the migration for the current time step is complete, and other time steps remain, the method returns to step 206 and can compute new weights. If the current time step is complete and no further time steps remain, the method proceeds to step 214. As used herein, a time step refers to a period of time within the migration duration. If, for example, the migration duration is seven days, a time step may comprise a 24-hour period (i.e., one day). Specific time values are not limiting.

Once all time steps have been completed, the method proceeds to step 214 where the old model is retired and predictions are served exclusively from the new model. In some implementations, this step can include deallocating the old ML model and using only the new model until a next version is created (after which the method can be executed again for the next version model).

To illustrate these steps, the preceding example is continued. In this continued example, the method may set a static migration duration of seven days and blend predictions for each time step as follows:

TABLE 1

| Time Step | Old Model Weight | New Model Weight |
|---|---|---|
| 1 | $\frac{6}{7} = 0.86$ | $\frac{1}{7} = 0.14$ |
| 2 | $\frac{5}{7} = 0.71$ | $\frac{2}{7} = 0.29$ |
| 3 | $\frac{4}{7} = 0.57$ | $\frac{3}{7} = 0.43$ |
| 4 | $\frac{3}{7} = 0.43$ | $\frac{4}{7} = 0.57$ |
| 5 | $\frac{2}{7} = 0.29$ | $\frac{5}{7} = 0.71$ |
| 6 | $\frac{1}{7} = 0.14$ | $\frac{6}{7} = 0.86$ |
| 7 | Retired | Used Exclusively |

Consider, then, as an example an old model that outputs a prediction of 0.8 and a new model outputting a prediction of 0.2. Using these weights, during serving the ultimate blended prediction can then be computed as follows:

TABLE 2

| Time Step | Old Model | New Model | Blended Model |
|---|---|---|---|
| 1 | 0.80 | 0.20 | 0.72 |
| 2 | 0.70 | 0.15 | 0.54 |
| 3 | 0.85 | 0.19 | 0.57 |
| 4 | 0.69 | 0.22 | 0.42 |
| 5 | 0.91 | 0.23 | 0.43 |
| 6 | 0.75 | 0.18 | 0.26 |
| 7 | 0.81 | 0.24 | 0.24 |

As illustrated, the method of FIG. 2 ultimately results in the new model being used in production exclusively. However, the migration duration and weighting allows for a smoother blending of models and reduces the jitter during each time step as the model is changed.

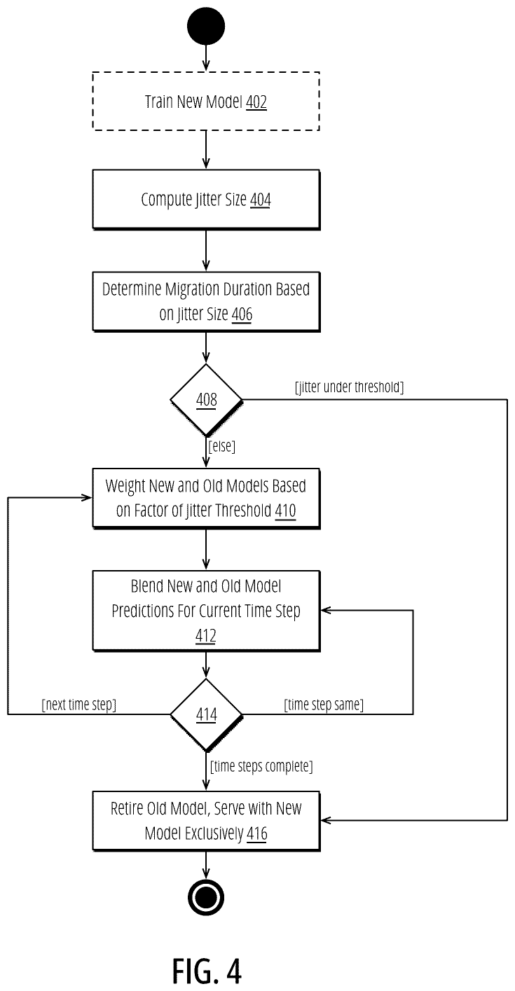

Specific techniques for computing a migration duration, adjusting a migration duration, and various other factors are described next in FIG. 3 (describing a fixed step technique), FIG. 4 (describing a pre-computed step technique), and FIG. 5 (describing a dynamic step technique).

To simplify some aspects of the following methods, the following terminology is used. M(Dⱼ, Cₖ) represents a model trained with training data Dⱼ and a model configuration Cₖ. As described in FIG. 1, a model improvement between an old model and a new model can refer to a change in the model configuration (e.g., rescaling being enabled). In the following discussion, C_{old} represents a current or old model configuration while C_{new} represents a new configuration. In some instances, Mₖ is used as a shorthand for the latest trained model. P(Dᵢ, Mₖ) refers to the predictions generated by applying the model Mₖ to inference dataset Dᵢ. Thus, P(Dᵢ, M_{old})=P_{i,old} and P(Dᵢ, M_{new})=P_{i,new} are the predictions for the old and new models, respectively. As used herein, jitter between models can be represented as a metric J for a given time step i, such that J=|P_{i,old}−P_{i,new}|. As discussed in FIGS. 4 and 5, a daily jitter threshold τ_{J} represents the daily jitter threshold used for duration determination. Finally, blended predictions for a given time step i are represented as P̅ₗ. Generally, a migration duration is measured from time step i=0 to i=T, where T represents the total number of time steps. Thus, the value of P̅ₗ can be computed as:

$$\overline{{P}_{0}} = {P}_{0 , old}$$

$$\overline{{P}_{ι}} = ( 1 - {λ}_{i} ) {P}_{i , old} + {λ}_{i} {P}_{i , new} , where 0 <= λ < = 1 for i = 0 , 1 , … T$$

$$\overline{{P}_{T}} = {P}_{T , new}$$

In these examples, T is the migration duration, 1/T is the migration time step, and λᵢ represents the model blend weight for a given time step i. When the time step (1/T) is time-invariant, on the i-th day, λᵢ=i/T.

FIG. 3 is a flow diagram illustrating a method for blending model predictions using a fixed step approach according to some of the example embodiments.

In step 302, the method can optionally include training a new model. Details of this step are provided in the description of step 202 and are not repeated herein but are incorporated by reference in their entirety.

In step 304, the method can include computing an estimated number of changes between an old or current model configuration and a new model configuration. This step can involve measuring the differences in the parameters or features that the two models use. Changes in this context can refer to various aspects depending on the nature of the machine learning model involved. These changes can be, as examples, parameter changes, feature changes, structural changes, or performance changes, each of which are described next.

For parameter changes, in some implementations, if the model is parametric, such as a neural network or a regression model, the differences in the parameter values between the old and the new model can be computed. This could involve computing the Euclidean distance (or any other suitable distance metric) between the vectors of parameters of the two models. For example, if the old model parameters are represented by the vector θ_{old} and the new model parameters by θ_{new}, the estimated number of changes could be computed as ||θ_{old}−θ_{new}||.

For feature changes, in some implementations, if new features are being added or existing features are being removed from the model, the number of added or removed features can be computed as the number of changes.

For structural changes, if the architecture of the model changes, for instance, in neural networks where you might add or remove layers, or in decision trees where the tree depth might change, this structural change could be quantified. For example, the method can compute a similarity score between model architectures.

For performance changes, in some implementations, if the performance metrics (like accuracy, precision, recall, F1 score, etc.) between the two models are significantly different, this could also be calculated as a change.

In order to calculate these changes, the method can implement a function or a series of functions that take as input the specifications of the two models and output a measure of their difference. These could include functions to compute parameter distances, feature differences, structural differences, or performance differences as described above. These measures of differences could then be added, weighted, or otherwise combined to produce an overall estimated number of changes between the two models. The specifics of this would depend on the exact nature of the models involved and the importance given to each kind of change in the particular application.

In step 306, the method can include determining a migration duration based on the estimated changes.

In some implementations, the number and extent of changes can then be converted into a numerical value representing a number of migration steps. For example, this can be done using a scaling function that translates the calculated changes into a number of time steps (e.g., a duration). Each unit of change could correspond to a specific time period. For instance, one unit of change could correspond to one day of the daily time steps. This would mean that if the calculated changes amount to a value of seven units, the migration duration would be set to seven days. Notably, a time step may not be limited to one day and any amount of time can be used as a time step duration. Alternatively, the system might use a more complex function to calculate migration duration, taking into account not only the number of changes but also the extent or severity of each change. For instance, a major structural change in the model might be assigned a higher “weight” in terms of migration duration than a minor parameter change. This weighted sum could then be used to calculate the migration duration. Further, this calculation could be adjusted based on the particular operational or business requirements of the system. For example, if quicker model transitions are essential, then the translation function might be designed to limit the maximum migration duration to a certain threshold (e.g., seven days), regardless of the number of changes. Finally, it's also possible that different types of changes could be associated with different time scales. For instance, parameter changes might be scaled to hours, feature changes to days, and structural changes to weeks. The final migration duration would then be a composite of these different time scales. This approach allows for more flexibility and can better account for the different impacts that different types of changes might have on the performance and stability of the model predictions.

In some implementations, the migration duration and time step are time invariant and thus fixed in step 306 for the remainder of the method.

In step 308, after determining a migration duration, the method executes the first time step and computes weights for the new and old model. In some implementations, the weights can be determined according to the migration duration. For example, the weights can be set such that the old model weights linearly decrease in equal increments over the duration of the migration while the new model weights linearly increase in equal increments over the duration of the migration, such that for any given time step, the sum of the old and new weights are one. Generally, the earlier the time step the higher the weighting of the old model and lower the weighting of the new model. A specific example of this (using a seven day migration duration) are provided in Table 1 and are described in step 206, which are not repeated herein.

In step 310, the method blends the new and old model predictions for the current time step. In this step, the method inputs inference data into both models to obtain separate predictive outputs. The method then can weight the outputs using the weights determined in step 308 and aggregate (e.g., sum) the outputs to form a blended output value. A specific example of this (using a seven day migration duration) is provided in Table 2 and are described in step 208, which are not repeated herein.

In step 312, the method can include determining the state of the migration. If the migration is still in the current time step, the method continues to serve predictions in step 310. If the migration for the current time step is complete, and other time steps remain, the method returns to step 308 and can compute new weights. If the current time step is complete and no further time steps remain, the method proceeds to step 314. As used herein, a time step refers to a period of time within the migration duration. If, for example, the migration duration is seven days, a time step may comprise a 24-hour period (i.e., one day). Specific time values are not limiting.

Once all time steps have been completed, the method proceeds to step 314 where the old model is retired and predictions are served exclusively from the new model. In some implementations, this step can include deallocating the old ML model and using only the new model until a next version is created (after which the method can be executed again for the next version model).

FIG. 4 is a flow diagram illustrating a method for blending model predictions using a computed step approach according to some of the example embodiments.

In step 402, the method can optionally include training a new model. Details of this step are provided in the description of step 202 and are not repeated herein but are incorporated by reference in their entirety.

In step 404, the method can include computing a jitter size.

As discussed, the jitter size can be computed as the difference in predictions on the same data between an old model and a new model. In some implementations, the jitter size can be computed by inputting a series of examples into both the current model and the new model and then comparing the outputs. Specifically, the jitter J of a model can be computed as |P_{0,old}−P_{0,new}| based on the model outputs.

In order to compute the jitter size, a common set of inference data is input into both the old and new models. This inference data can consist of several examples, representing, for example, a wide range of possible inputs the models could encounter in actual use. The predictions from the old and new models, P_{0,old} and P_{0,new} respectively, are compared to compute the jitter. One way to perform this comparison is to utilize Cohen's d to determine a difference between the prediction of the old model from that of the new model, for each data point in the inference data (i.e., P_{0,old}−P_{0,new}). In some implementations, the absolute value of these differences is taken to remove any directionality from the comparison, representing the magnitude of the change (i.e., |P_{0,old}−P_{0,new}|).

This computation is done for each data point in the inference data, and the results can then be aggregated to form an overall jitter size. The aggregation can be performed in different ways, depending on the specific needs of the system. For instance, one could take the mean, median, maximum, or some other statistic of the jitter sizes across all data points. Thus, the jitter computation step can provide a valuable measure of how the old and new models differ in their predictions.

In step 406, the method can compute a migration duration (T) based on the jitter size. In some implementations, the migration duration T can be computed as:

$$T = ⌈ \vert {P}_{0 , old} - {P}_{0 , new} \vert / {τ}_{J} ⌉ \qquad Equation 1$$

Here, τ_{J} represents a jitter threshold that determines the amount of difference in predictions that is considered acceptable within a single time step (e.g., a day). The numerator of the fraction, |P_{0,old}−P_{0,new}|, represents the jitter size. By dividing the jitter size by the threshold, the method can obtain a measure of the number of time steps required to transition from the old to the new model such that the change in predictions in each step does not exceed the threshold. The ceiling function, which rounds up to the nearest whole number, ensures that the migration duration is always a whole number of time steps. This operation may be optional depending on the time scale.

Thus, if |P_{0,old}−P_{0,new}|≤τ_{J}, only a single day will be required for migration. This is because the difference in predictions between the two models is already within acceptable limits. On the other hand, if the jitter size is seven times the threshold (|P_{0,old}−P_{0,new}|=7τ_{J}) then seven days will be required for migration. This reflects the fact that a larger difference in predictions necessitates a more gradual transition. In some implementations, the migration time step may remain time invariant while the duration is sized based on the jitter.

In step 410, after determining a migration duration, the method executes the first time step and computes weights for the new and old model based on the jitter threshold. In some implementations, the weights can be determined according to the migration duration. For example, the weights can be set such that the old model weights linearly decrease in equal increments over the duration of the migration while the new model weights linearly increase in equal increments over the duration of the migration, such that for any given time step, the sum of the old and new weights are one. Generally, the earlier the time step the higher the weighting of the old model and lower the weighting of the new model. A specific example of this (using a seven day migration duration) are provided in Table 1 and are described in step 206, which are not repeated herein.

In step 412, the method blends the new and old model predictions for the current time step. In this step, the method inputs inference data into both models to obtain independent predictive outputs. The method then can weight the outputs using the weights determined in step 410 and aggregate (e.g., sum) the outputs to form a blended output value. A specific example of this (using a seven day migration duration) is provided in Table 2 and are described in step 208, which are not repeated herein.

In step 414, the method can include determining the state of the migration. If the migration is still in the current time step, the method continues to serve predictions in step 412. If the migration for the current time step is complete, and other time steps remain, the method returns to step 410 and can compute new weights. If the current time step is complete and no further time steps remain, the method proceeds to step 416. As used herein, a time step refers to a period of time within the migration duration. If, for example, the migration duration is seven days, a time step may comprise a 24-hour period (i.e., one day). Specific time values are not limiting.

Once all time steps have been completed, the method proceeds to step 416 where the old model is retired and predictions are served exclusively from the new model. In some implementations, this step can include deallocating the old ML model and using only the new model until a next version is created (after which the method can be executed again for the next version model).

FIG. 5 is a flow diagram illustrating a method for blending model predictions using a dynamically computed step approach according to some of the example embodiments.

In step 502, the method can optionally include training a new model. Details of this step are provided in the description of step 202 and are not repeated herein but are incorporated by reference in their entirety.

In step 504, the method can include computing an initial jitter of the old and new model. This process of computing a jitter is described in FIG. 4 and, in particular, step 404 which is not repeated herein.

In step 506, the method then determines if the jitter is under a threshold. As discussed above, if the jitter is under one factor of a jitter threshold (i.e., |P_{0,old}−P_{0,new}|≤τ_{J}, then the method can proceed directly to step 518 and immediately serve the new model. By contrast, if the jitter exceeds the jitter threshold (i.e., by one or more multiples), then the method can proceed to step 508. In some implementations, step 506 can further involve computing an initial migration duration as discussed above. Specifically, an initial duration can be computed as T₀=[P_{0,old}−P_{0,new}|_{J}//τ_{J}]=nτⱼ, where n represents a multiple of the jitter threshold which can be used as the migration duration (e.g., in days). In some implementations, step 506 can also include determining if the migration duration is equal to or below one and branching to step 518 if so.

In step 508, the method can compute a blend weight (λᵢ) for the current time step i. In some implementations, the method can compute a blend weight (λᵢ) following the following constraints. First, since Tᵢ (the duration at a current time step i) is time-variant, the method may enforce that the blend weight (λᵢ) comprise a sum of all the migration time step blending weights that have been taken (i.e., Σ₁ⁱi/Tᵢ). Second, the method may enforce that the current blend weight (λᵢ) not exceed one, such that

$${λ}_{i} = min ( {\sum }_{1}^{i} \frac{i}{{T}_{i}} , 1 ) .$$

Examples of this step are provided later as the step is repeated at the beginning of each time step. Since i/Tᵢ is greater than 0, λ will always converge to one. It means the method, even with dynamic steps, will always finish.

In step 516, the method can include determining if the blend weight has converged to one. In contrast to FIGS. 3 and 4, the blend weight in FIG. 5 may be used as the terminating variable. Specifically, once the blend weight, which is continuously re-computed saturates the method will terminate the migration and the method proceeds to step 518, where the old model is retired and predictions are served exclusively from the new model. In some implementations, this step can include deallocating the old ML model and using only the new model until a next version is created (after which the method can be executed again for the next version model).

If the blend weight is still below one, the method will instead continue migrating by branching to step 510 where the models are provided with inference data to obtain blended predictions.

In step 510, after determining a migration duration and blend weight and and confirming the blend weight has not converged, the method executes the time step and weights the old and new models based on the blend weight to obtain a blended prediction. In some implementations, the method can compute a weight for the new model based on the blend weight and also compute a weight for the old model based on the blend weight such that the sum of both weights is equal to one. As example, assume that T₁ is computed (based on the foregoing description) to be seven (i.e., a seven day migration), the blend weight can be computed as:

$${λ}_{1} = ( {\sum }_{1}^{i} \frac{i}{{T}_{i}} , 1 ) = ( \frac{1}{7} , 1 ) = \frac{1}{7} \qquad Equation 2$$

Using this blend weight (λ₁) the method can compute the new model blend weight as 1/7 and the old model blend weight as 1− 1/7= 6/7.

Next, in step 512, the method can then blend the predictions using these weights to obtain a set of predictions for time step i (i.e., Pᵢ). In this step, the method inputs inference data into both models to obtain independent predictive outputs. The method then can weight the outputs using the weights determined in step 510 and aggregate (e.g., sum) the outputs to form a blended output value. The method will then complete the time step and return to step 504 where the next time step's jitter and duration is computed. The process will thus continue until either the jitter is acceptable or the blend weight converges.

The following example illustrates the loop starting at step 504 and completing with step 516. In this example, an initial jitter size is computed by comparing the outputs of the new and old models and an initial duration of seven (7) days is computed in step 506, as discussed. The initial blend weight for time step 1 is then computed as:

$${λ}_{1} = ( {\sum }_{1}^{i} \frac{i}{{T}_{i}} , 1 ) = ( \frac{1}{7} , 1 ) = \frac{1}{7}$$

The method then weights the models as follows:

$$\overline{{P}_{1}} = ( 1 - {λ}_{1} ) {P}_{1 , old} + {λ}_{1} {P}_{1 , new} = \frac{6}{7} {P}_{1 , old} + \frac{1}{7} {P}_{1 , new}$$

After serving predictions in step 512 the method then computes the jitter for time step 1 in step 514 as [P_{1,old}−P_{1,new}|_{J}//τ_{J}]. Assume, for this example, that the migration duration using this current jitter is computed as five (5) days in time step 2 (T₂). Since this duration is greater than one (step 506), the method then computes a new blend weight for T₂ as follows:

$${λ}_{2} = ( {\sum }_{1}^{i} \frac{i}{{T}_{i}} , 1 ) = ( \frac{1}{7} + \frac{1}{5} , 1 ) = \frac{12}{35}$$

Since the blend weight is under one, the method continues and serves inference data and computes a new jitter. This process, as discussed, will continue until the value of the blend weight converges to one, wherein the method will terminate. Table 3 below provides a complete example of each time step and the corresponding time step jitter and blend weight:

TABLE 3

| Time Step (i) | Updated Duration (Tᵢ) | Blend Weight (λᵢ) |
|---|---|---|
| 1 | 7 | $\frac{1}{7}$ |
| 2 | 5 | $\frac{1}{7} + \frac{1}{5} = \frac{12}{35}$ |
| 3 | 9 | $\frac{1}{7} + \frac{1}{5} + \frac{1}{9} = \frac{143}{315}$ |
| 4 | 4 | $\frac{1}{7} + \frac{1}{5} + \frac{1}{9} + \frac{1}{4} = \frac{887}{1260}$ |
| 5 | 8 | $\frac{1}{7} + \frac{1}{5} + \frac{1}{9} + \frac{1}{4} + \frac{1}{8} = \frac{2089}{2520}$ |
| 6 | 3 | $\frac{1}{7} + \frac{1}{5} + \frac{1}{9} + \frac{1}{4} + \frac{1}{8} + \frac{1}{3} = 1 \frac{409}{2520}$ |

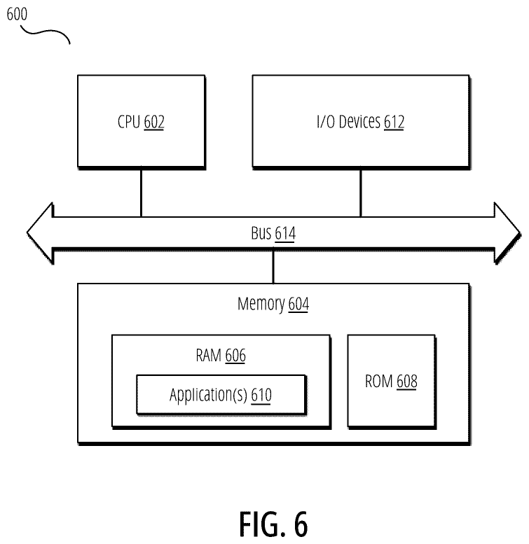

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
loading a first model and a second model, the second model comprising a later version of the first model;
computing a migration duration based on a computed property of the first model and the second model;
inputting inference data into both the first model and the second model;
blending outputs of the first model with outputs of the second model according to weights computed for a first time step of the migration duration; and
serving second inference data using the second model when migration duration expires.

2. The method of claim 1, wherein computing the migration duration based on the computed property of the first model and the second model comprises:
computing an estimated number quantifying the scale of changes of the second model when compared to the first model; and
computing the migration duration based on the estimated number quantifying the scale of changes.

3. The method of claim 2, wherein blending the outputs of the first model with outputs of the second model comprises linearly computing a first weight of the first model and a second weight of the second weight of the second model based on the first time step, wherein a sum of the first weight and the second weight is equal to one.

4. The method of claim 1, wherein computing the migration duration based on the computed property of the first model and the second model comprises:
computing a jitter size of the second model when compared to the first model; and
computing the migration duration based on the jitter size and a predefined jitter size.

5. The method of claim 4, wherein computing the migration duration based on the jitter size comprises dividing the jitter size by a jitter threshold to obtain the migration duration.

6. The method of claim 1, further comprising:
computing second weights for a second time step according to a model blend weight, the model blend weight based on a jitter size of a blended output of the first time step and a model blend weight computed for the first time step; and
blending outputs of the first model with outputs of the second model according to the second weights.

7. The method of claim 6, further comprising determining that the migration duration expires when a summation of previous model blend weight is equal to one.

8. A non-transitory computer-readable storage medium for tangibly storing computer program instructions capable of being executed by a computer processor, the computer program instructions defining steps of:
loading a first model and a second model, the second model comprising a later version of the first model;
computing a migration duration based on a computed property of the first model and the second model;
inputting inference data into both the first model and the second model;
blending outputs of the first model with outputs of the second model according to weights computed for a first time step of the migration duration; and
serving second inference data using the second model when migration duration expires.

9. The non-transitory computer-readable storage medium of claim 8, wherein computing the migration duration based on the computed property of the first model and the second model comprises:
computing an estimated number quantifying the scale of changes of the second model when compared to the first model; and
computing the migration duration based on the estimated number quantifying the scale of changes.

10. The non-transitory computer-readable storage medium of claim 9, wherein blending the outputs of the first model with outputs of the second model comprises linearly computing a first weight of the first model and a second weight of the second weight of the second model based on the first time step, wherein a sum of the first weight and the second weight is equal to one.

11. The non-transitory computer-readable storage medium of claim 8, wherein computing the migration duration based on the computed property of the first model and the second model comprises:
computing a jitter size of the second model when compared to the first model; and
computing the migration duration based on the jitter size and a predefined jitter size.

12. The non-transitory computer-readable storage medium of claim 11, wherein computing the migration duration based on the jitter size comprises dividing the jitter size by a jitter threshold to obtain the migration duration.

13. The non-transitory computer-readable storage medium of claim 8, the steps further comprising:
computing second weights for a second time step according to a model blend weight, the model blend weight based on a jitter size of a blended output of the first time step and a model blend weight computed for the first time step; and
blending outputs of the first model with outputs of the second model according to the second weights.

14. The non-transitory computer-readable storage medium of claim 13, the steps further comprising determining that the migration duration expires when a summation of previous model blend weight is equal to one.

15. A device comprising:
a processor; and
a storage medium for tangibly storing thereon logic for execution by the processor, the logic comprising instructions for:
loading a first model and a second model, the second model comprising a later version of the first model,
computing a migration duration based on a computed property of the first model and the second model,
inputting inference data into both the first model and the second model,
blending outputs of the first model with outputs of the second model according to weights computed for a first time step of the migration duration, and
serving second inference data using the second model when migration duration expires.

16. The device of claim 15, wherein computing the migration duration based on the computed property of the first model and the second model comprises:
computing an estimated number quantifying the scale of changes of the second model when compared to the first model; and
computing the migration duration based on the estimated number quantifying the scale of changes.

17. The device of claim 16, wherein blending the outputs of the first model with outputs of the second model comprises linearly computing a first weight of the first model and a second weight of the second weight of the second model based on the first time step, wherein a sum of the first weight and the second weight is equal to one.

18. The device of claim 15, wherein computing the migration duration based on the computed property of the first model and the second model comprises:
computing a jitter size of the second model when compared to the first model; and
computing the migration duration based on the jitter size and a predefined jitter size.

19. The device of claim 18, wherein computing the migration duration based on the jitter size comprises dividing the jitter size by a jitter threshold to obtain the migration duration.

20. The device of claim 15, the instructions further comprising:
computing second weights for a second time step according to a model blend weight, the model blend weight based on a jitter size of a blended output of the first time step and a model blend weight computed for the first time step; and
blending outputs of the first model with outputs of the second model according to the second weights.
